(19) United States
(12) Patent Application Publication
(10) Pub. No.: US 2017/0303007 A1
(43) Pub. Date: Oct. 19, 2017

(54) SYSTEM AND METHOD FOR TRASMITTING WARNING SIGNAL BASED ON EMERGENCY ALERT SYSTEM SIGNAL

(71) Applicant: ARRIS Enterprises LLC, Suwanee, GA (US)

(72) Inventors: Scott Stilwell, Suwanee, GA (US); Dmitry Barablin, Lawrenceville, GA (US); Sergey Kozlov, Billerica, MA (US)

(21) Appl. No.: 15/130,542

(22) Filed: Apr. 15, 2016

(51) Int. Cl. H04N 21/488; H04N 21/61

(52) U.S. Cl. CPC H04N 21/4882; H04N 21/6181

(57) ABSTRACT

A device is provided for use with a wireless communication device and with a video display. The device includes a receiver, an image decoder, an emergency alert system (EAS) decoder, an output port, a memory, a warning generator and a transmitter. The receiver receives input data including image data and EAS data. The image decoder decodes the image data into image display data. The EAS decoder decodes the emergency alert system data into emergency alert data. The output port outputs the image display data to the video display to display a video image. The memory stores contact information associated with the wireless communication device. The warning generator generates a warning signal based on the emergency alert data. The transmitter transmits a warning transmission to the wireless communication device over a cellular network, wherein the warning transmission is based on the warning signal and the contact information.

### BACKGROUND

Embodiments of the invention relate to devices and methods for communication.

The Emergency Alert System (EAS) is a national public warning system that requires broadcaster, cable television systems, wireless cable systems, satellite digital audio radio service providers, and direct broadcast satellite providers to provide communications capability to address the public during a national or local emergency. Communications can include information related to national security, AMBER alerts, and weather related information. As a result, the EAS can access every set top box (STB) to deliver emergency information individuals watching television. The operation of a conventional EAS system will be described with reference to FIG. 1.

FIG. 1 illustrates the operation of a conventional EAS system. As shown in the figure, a system 100 includes an EAS 102, a set top box 104, and a television 106. Set top box 104 and television 106 are located inside a house 112, whereas EAS 102 is located outside house 112.

EAS 102 communicates with set top box 104 via a communication line 108 and set top box 104 communicates with television 106 via a communication line 110.

In operation, EAS 102 is a system that can be activated by a local official to notify residents of an emergency, such as for example an incoming hurricane. In such an emergency, it may be required for all residents to evacuate or seek immediate shelter.

When EAS 102 is activated, EAS 102 provides information about the incoming hurricane to set top box 104 via communication line 108.

Set top box 104 then provides information received from EAS 102 to television 106 via communication line 110. The information sent from EAS 102 to television 106 through set top box 104 is now to be seen by the viewer on the television screen. The viewer is notified through the television screen to evacuate or seek shelter due to the impending hurricane and advised to the appropriate action.

A problem arises, though, when the viewer is unable to see the information. The problem can arise when television 106 is not on or is in sleep mode, or when the viewer is not at home, or when the viewer is at home but is not in the same location as television 106. In any of those cases, the viewer would not see the message and would not know that a hurricane was coming.

There exists a need for a more effective way to notify an individual of EAS warnings when the individual is not near a conventional EAS notification device.

### SUMMARY

Aspects of the present invention are drawn to a system and method to notify an individual of EAS warnings when the individual is not near a conventional EAS notification device.

A device a device is provided for use with a wireless communication device and with a video display operable to display a video. The device includes a receiver, an image decoder, an emergency alert system decoder, an output port, a memory, a warning generator and a transmitter. The receiver receives input data including image data and emergency alert system data. The image decoder decodes the image data into image display data. The emergency alert system decoder decodes the emergency alert system data into emergency alert data. The output port outputs the image display data to the video display to display a video image. The memory stores contact information associated with the wireless communication device. The warning generator generates a warning signal based on the emergency alert data. The transmitter transmits a warning transmission to the wireless communication device over a cellular network, wherein the warning transmission is based on the warning signal and the contact information.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates the operation of a conventional EAS system;

FIG. 2 illustrates the operation of an EAS system in accordance with aspects of the present invention;

FIG. 3 illustrates a set top box in accordance with aspects of the present invention;

FIG. 4 illustrates the operation of another EAS system in accordance with aspects of the present invention;

FIG. 5 illustrates another set top box in accordance with aspects of the present invention;

FIG. 6 illustrates the operation of a localized EAS system in accordance with aspects of the present invention; and

FIG. 7 illustrates a process by which a user is notified of an EAS warning in accordance with aspects of the present invention.

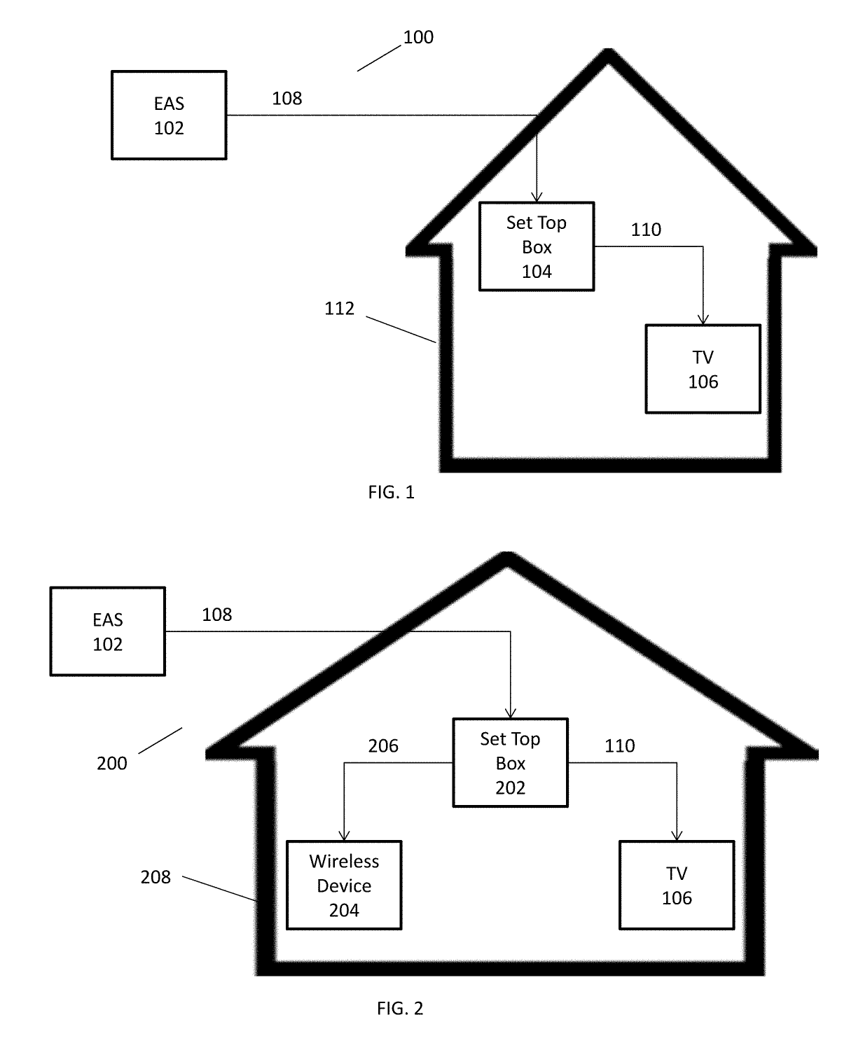

### DETAILED DESCRIPTION

The present invention provides a device and method to notify a user of an EAS warning even if the user is not near a conventional EAS enabled device like a television or radio.

The invention provides a set top box that can connect with a user's mobile phone to send an EAS message to the user's mobile phone. When an EAS message is provided to the set top box, the set top box converts the message to a format that is compatible with the mobile phone, and sends the message to the mobile phone wirelessly so the user is notified of the emergency.

The invention also provides a set top box that can connect with other household items connected to the Internet. The household items can notify the set top box of a household emergency (e.g., a broken water pipe), and the set top box can wirelessly send a message to the user's mobile phone to notify the user of the emergency.

Aspects of the present invention will now be described with reference to FIGS. 2-7.

FIG. 2 illustrates the operation of an EAS system in accordance with aspects of the present invention.

As shown in the figure, system 200 includes an EAS 102, a set top box 202, television 106, and a wireless device 204. Set top box 202, television 106, and wireless device 204 are located inside of a house 208, whereas EAS 102 is located outside of house 208.

EAS 102 communicates with set top box 202 via communication line 108. Set top box 202 communicates with television 106 and wireless device 204 via communication lines 110 and 206, respectively.

Wireless device 204 may include mobile phones, tablet computers, laptop computers or any other device that is capable of communicating via wireless means.

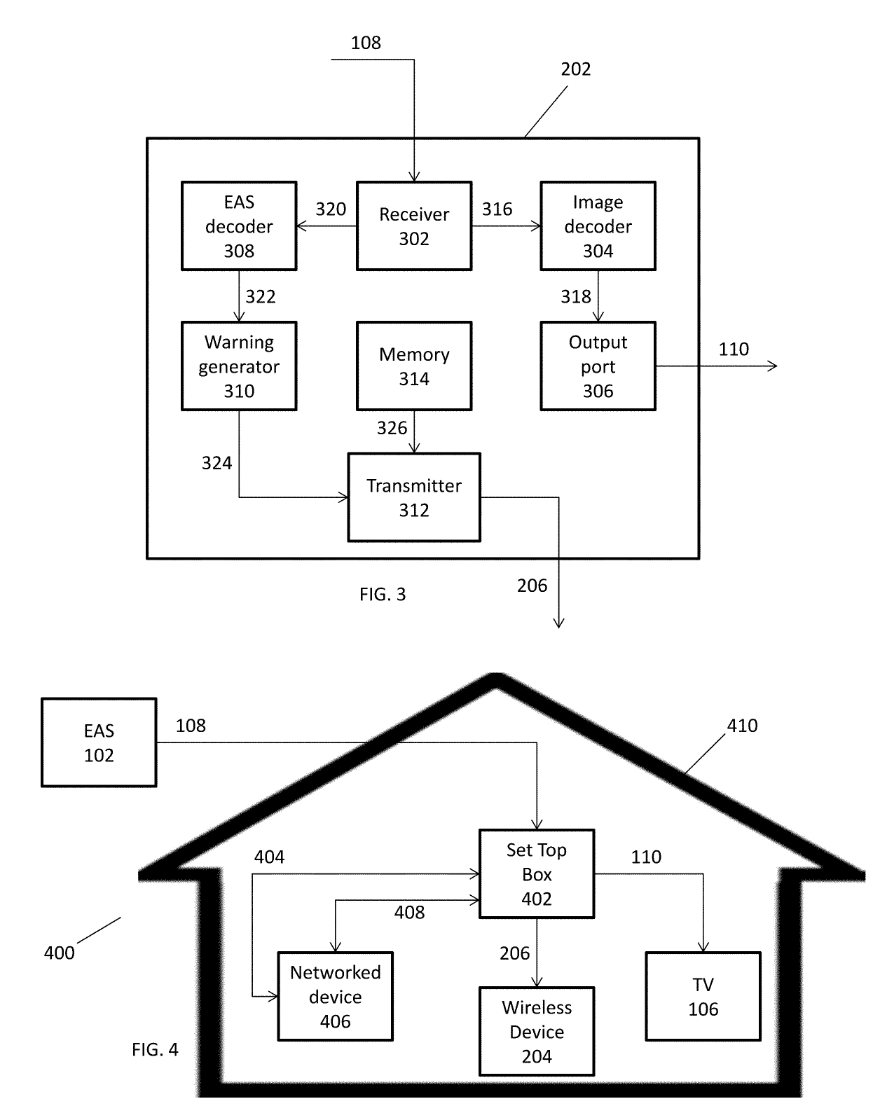

FIG. 3 illustrates a set top box in accordance with aspects of the present invention.

As shown in the figure, set top box 202 includes a receiver 302, an image decoder 304, an output port 306, an EAS decoder 308, a warning generator 310, a transmitter 312 and a memory 314.

Receiver 302 receives input data, which includes image data and EAS data from EAS 102 (not shown) via communication line 108. Receiver 302 provides image data to image decoder 304 via a communication line 316. Furthermore, receiver 302 also provides EAS data to EAS decoder 308 via a communication line 320.

Image decoder 304 receives image data from receiver 302 via communication line 316. Image decoder 314 then decodes the image data and provides the decoded image data to output port 306 via a communication line 318.

Output port 306 receives decoded image data from image decoder 304 via communication line 318 and sends the decoded image data to television 106 (not shown) via communication line 110.

EAS decoder 308 receives EAS data from receiver 302 via communication line 320. EAS decoder 308 then decodes the EAS data into emergency alert data and provides the emergency alert data to warning generator 310 via a communication line 322.

Warning generator 310 receives emergency alert data from EAS decoder 308 via communication line 322. Warning generator 310 generates a warning signal based on the EAS data and provides the warning signal to transmitter 312 via a communication line 324.

Memory 314 stores contact information for wireless device 204 and provides that contact information to transmitter 312 via a communication line 326.

Transmitter 312 receives a warning signal from warning generator 310 via communication line 324. Transmitter 312 also receives contact information for wireless device 204 from memory 314 via communication line 326. Furthermore, transmitter 312 then uses the contact information and sends the warning signal to wireless device 204 via communication line 206.

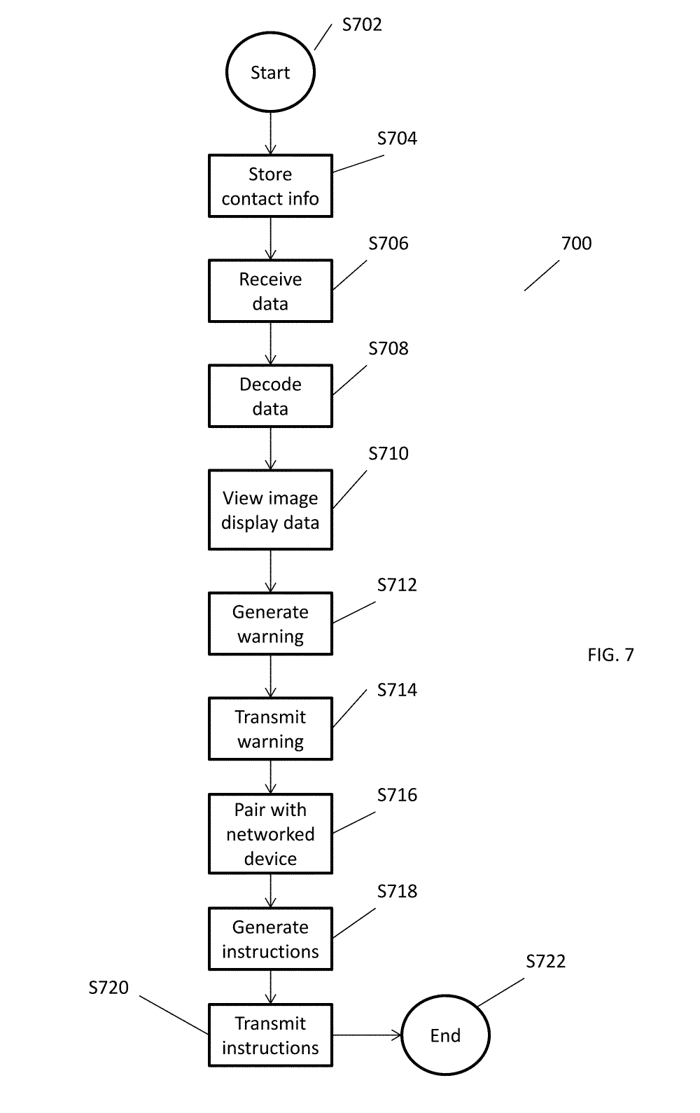

The operation of set top box 202, receiver 302, image decoder 304, output port 306, EAS decoder 308, warning generator 310, transmitter 312 and memory 314 will be further described with reference to FIG. 7.

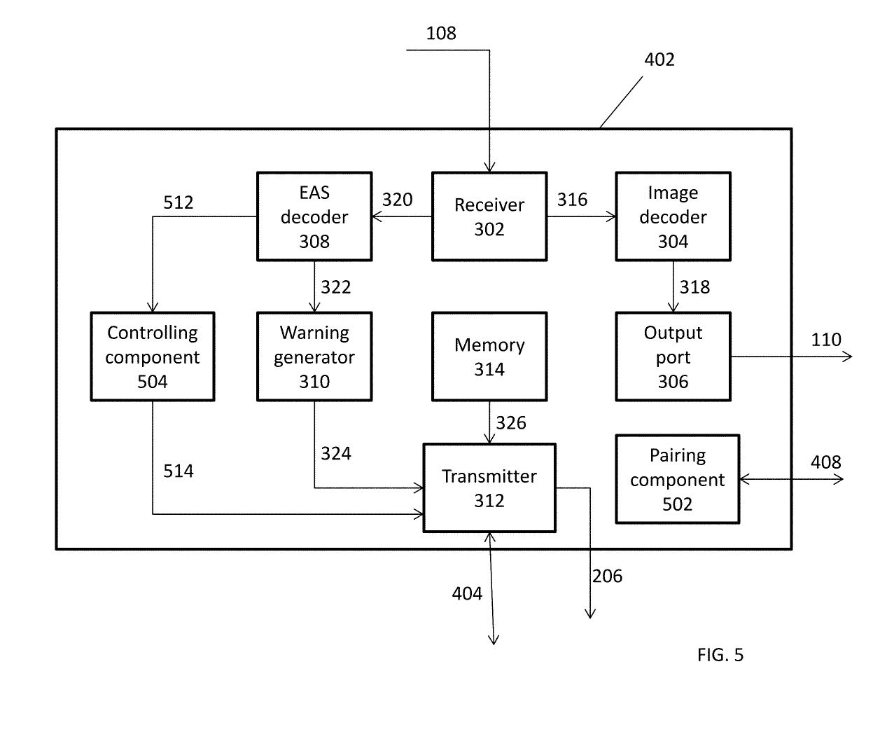

FIG. 4 illustrates the operation of another EAS system in accordance with aspects of the present invention.

As shown in the figure, a system 400 includes EAS 102, a set top box 402, television 106, wireless device 204 and a networked device 406. Set top box 202, television 106, wireless device 204 and networked device 406 are located inside of a house 410, whereas EAS 102 is located outside of house 410.

Networked device 406 may be any device that is capable of communicating wirelessly with another device. As non-limiting examples, networked device 406 may include a thermostat, water shut-off valve, light switch, or electrical outlet.

Networked device 406 and set top box 402 communicate with each other via a communication line 408. Set top box 402 can issue command instructions to networked device 406 via a communication line 404.

The operation of system 400 will be further described with reference to FIG. 7 and set top box 402 will be further described with reference to FIG. 5.

FIG. 5 illustrates another set top box in accordance with aspects of the present invention.

As shown in the figure, set top box 402 includes receiver 302, image decoder 304, output port 306, EAS decoder 308, warning generator 310, transmitter 312, memory 314, a pairing component 502 and a controlling component 504.

Pairing component 502 communicates with a networked device (not shown) via communication line 408 to pair set top box 402 and a networked device, such that the two devices can communicate with each other. Pairing can occur using any known method, including but not limited to, Bluetooth, Bluetooth Low Energy or Wi-Fi.

Controlling component 504 receives decoded EAS data from EAS decoder 308 via a communication line 512, creates an instruction signal based on the decoded EAS data and provides the instruction signal to transmitter 312 via a communication line 514.

Transmitter 312 receives the instruction signal from controlling component 504 via communication line 514 and transmits the instruction signal to a networked device via communication line 404.

The operation of set top box 402, receiver 302, image decoder 304, output port 306, EAS decoder 308, warning generator 310, transmitter 312, memory 314, pairing component 502 and controlling component 504 will be further described with reference to FIG. 7.

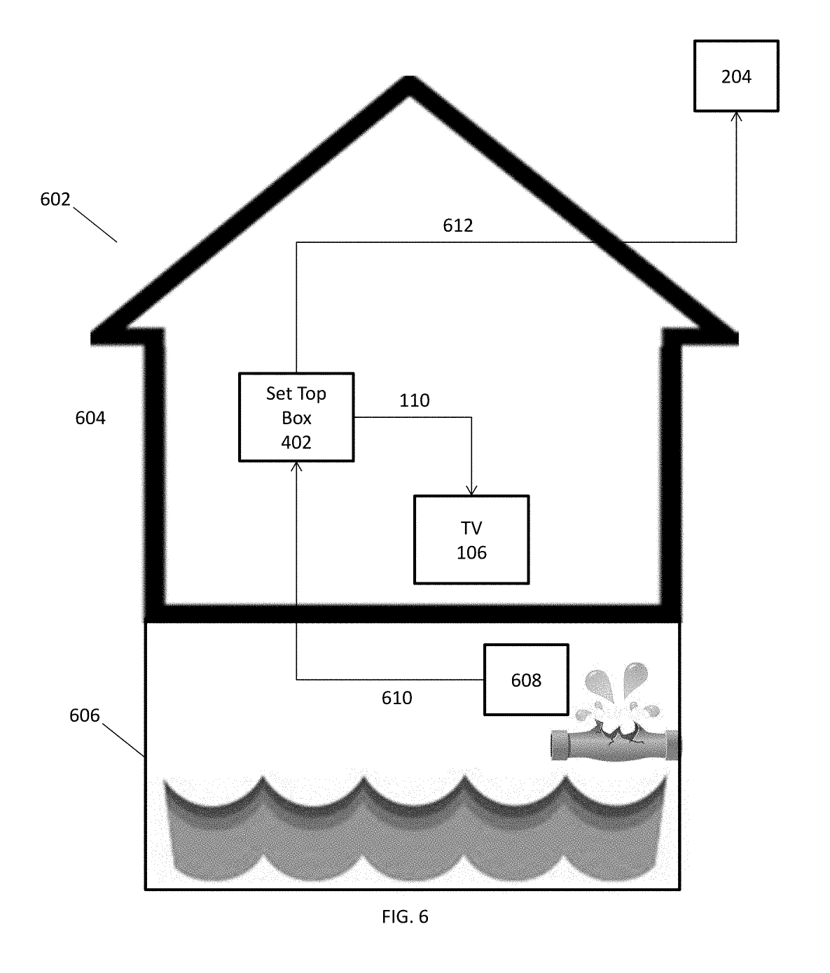

FIG. 6 illustrates the operation of a localized EAS system in accordance with aspects of the present invention.

As shown in the figure, a system 602 includes a house 604, a basement 606, a sensor 608, set top box 402, television 106 and wireless device 204.

Sensor 608 is located in basement 606 and communicates with set top box 402 via a communication line 610. As a non-limiting example, sensor 608 may sense environmental conditions in the basement to detect when flooding has occurred.

Set top box 402 and television 106 are located within house 604 and wireless device 204 is not located within house 604.

The operation of sensor 608, set top box 402 and wireless device 204 will be further described with reference to FIG. 7.

FIG. 7 illustrates a process by which a user is notified of an EAS warning in accordance with aspects of the present invention.

As shown in the figure, a process 700 starts (S702) and contact information is stored (S704).

Referring to FIG. 3, memory 314 stores contact information for wireless device 204 (not shown). Storing this information may be done in a variety of ways. The user may store the information on the set top box via a graphical user interface on television 106 (not shown). The user may also store the information online via the cable service's website, where the information entered on the website is then uploaded to memory 314. In general, the user may store the contact information via any known means for storing contact information. The information may include but is not limited to, mobile phone numbers, email addresses, twitter account handles and social media user names associated with the user.

Returning to FIG. 7, data is then received (S706).

Referring to FIG. 2, as a non-limiting example, the state government may have initiated EAS 102 because a hurricane is coming and the residents need to be informed. EAS 102 sends input data regarding the hurricane to set top box 202 via communication line 108.

Referring now to FIG. 3, receiver 302 receives the input data via communication line 108. The input data includes image data for display on a television screen and EAS data. Receiver 302 sends the image data to image decoder 304 via communication line 316. Receiver also sends the EAS data to EAS decoder 308 via communication line 320.

Returning to FIG. 7, data is then decoded (S708).

Referring to FIG. 3, image decoder 304 decodes the image data to create image display data that is in the appropriate format for viewing on a television. Image decoder 304 then sends the image display data to output port 306 via communication line 318. Any known method of decoding can be used to decode the data to the appropriate format.

EAS decoder 308 decodes the EAS data into emergency alert data that is in the appropriate format to be received by a wireless device. EAS decoder 308 then sends the emergency alert data to warning generator 310 via communication line 322. Any known method of decoding can be used to decode the data to the appropriate format.

Returning to FIG. 7, an image display data is viewed (S710).

Referring to FIGS. 2 and 3, output port 306 sends image display data to television 106 via communication line 110. At this point, the emergency alert is displayed on television 106. If the user were to be watching television, the user would see the alert notification and would be advised to take cover or evacuate the area before the hurricane arrives. However, the television may not be on, or the user may be in a different room at the time the alert is displayed and he may not actually receive the alert as intended.

Returning to FIG. 7, a warning is generated (S712).

Referring to FIG. 3, warning generator 310 generates a warning signal based on the emergency alert data and sends the warning signal to transmitter 312 via communication line 324.

Returning to FIG. 7, a warning is transmitted (S714).

Referring to FIGS. 2 and 3, transmitter 312 uses contact information from memory 314 to transmit the warning signal to wireless device 204 via communication line 206. In case television 106 is not on, or in case the user is in a different room at the time the emergency alert is displayed on the television, the user would not see the alert. However, it is likely that the user is carrying wireless device 204 such that the warning signal would reach wireless device 204 and notify the user of the incoming hurricane. The warning signal may include audio data, like an alarm or buzzing sound, or even a recorded audio message telling him to take cover or evacuate. The warning signal may also include text data, like a written warning to alert the user to take cover or evacuate.

It can be appreciated that, while the discussion of steps S702 through S714 were described with respect to FIGS. 2 and 3, the discussion applies to FIGS. 4 and 5 as well because set top box 402 contains the same components as set top box 202. The discussion above focused on FIGS. 2 and 3 for purposes of brevity and simplicity.

Returning to FIG. 7, the set top box then pairs with a networked device (S716).

Referring now to FIGS. 4 and 5, pairing component 502 pairs with networked device 406 via communication line 408. Pairing may occur via any conventional method used to pair two or more devices wirelessly, including but not limited to, Bluetooth. In continuing to use the example of an impending hurricane, networked device 406 may be hurricane shutters that can cover the windows of house 410 to prevent the windows from shattering.

Returning to FIG. 7, instructions are generated (S718).

Referring to FIG. 5, after EAS decoder 308 sends the emergency alert data to controlling component 504 via communication line 512, controlling component 504 generates instructions based on the emergency alert data and sends the instructions to transmitter 312 via communication line 514.

Returning to FIG. 7, the instructions are then transmitted (S720).

Referring to FIGS. 4 and 5, transmitter 312 transmits the instructions to networked device 406 via communication line 404. The instructions contain information that networked device 406 will use to modify its operation in response to the instructions. As a non-limiting example, if networked device 406 is referred to as hurricane shutters, the instructions may be to close the shutters if they are not already closed. When the shutters receive the instructions, they will automatically close in response to the instructions. This type of automatic response may be especially useful if the user is not home to manually close the shutters, or if the user already evacuated the area and forgot to close the shutters. The user would not have to worry because the system is able to take those measures on its own.

In some situations, there may be an instance where networked device 406 is unable to execute the instructions provided to it by transmitter 312. In those cases, networked device 406 will notify transmitter 312 via communication line 404 that it was unable to execute the instructions and transmitter 312 would then send a message to wireless device 204 via communication line 206 to notify the user that networked device 406 was unable to execute the instructions. Using the current example, after receiving the instructions and attempting to close, the hurricane shutters are unable to close. Networked device 406, in this case the shutters, then generate a signal regarding the failure and send that signal to transmitter 312. Transmitter 312 then sends a notification to wireless device 204 with the information of the failure of shutters to close. The user will view the notification and can then take the appropriate action. The user can attempt to close the shutters if still at home. If the user is not at home, a neighbor can attempt to close the shutters at the user's request.

Returning to FIG. 7, process 700 ends (S722).

Referring back to FIG. 6, another embodiment of the present invention includes a system in which the emergency alert data is generated at the household level using essentially the same process 700 as described above.

As a non-limiting example, sensor 608 may be a moisture sensor that is designed to send an alert when the moisture level gets too high. This type of sensor may be beneficial to detect a flood in the basement. If sensor 608 detects a high level of moisture, it will notify set top box 402 of the emergency situation via communication line 610. Set top box 402 will then send an emergency alert to television 106 via communication line 110. Set top box 402 will also send an emergency alert to wireless device 204 via communication line 612. If the user is at home or nearby, the user can come home and deal with the situation. However, if the user is out of town it may not be possible to deal with the situation. In that case, the user may be able to issue a command to set top box 402 to shut off the water supply to the house to avoid any further damage. In another embodiment, set top box 402 may automatically shut off the water supply to the house in response to the emergency notification. This is similar to how the system closed the hurricane shutters in the example above.

In summary, the present invention provides a device and method to receive EAS warnings and effectively communicate the warnings to individuals not near a conventional EAS equipped device like a television or a radio. The present invention also provides a device and method to modify the operation of a networked device in response to EAS warnings. The devices and methods of the present invention may also be used on the household level, where emergency warnings and networked device operation modification can occur based on emergencies specific to a single home, like a flood.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a wireless communication device and for use with a video display operable to display a video, said device comprising:
a receiver operable to receive input data including image data and emergency alert system data;
an image decoder operable to decode the image data into image display data;
an emergency alert system decoder operable to decode the emergency alert system data into emergency alert data;
an output port operable to output the image display data to the video display to display a video image;
a memory operable to store contact information associated with the wireless communication device;
a warning generator operable to generate a warning signal based on the emergency alert data; and
a transmitter operable to transmit a warning transmission to the wireless communication device over a cellular network, the warning transmission being based on the warning signal and the contact information.

2. The device of claim 1,
wherein said receiver is operable to receive the input data such that the emergency alert system data includes encoded audio data for transmission over the cellular network,
wherein said emergency alert system decoder is operable to decode the encoded audio data into decoded audio data, and
wherein said transmitter is operable to transmit the warning transmission so as to include an audio instruction based on the decoded audio data.

3. The device of claim 1,
wherein said receiver is operable to receive the input data such that the emergency alert system data includes encoded text data for transmission over the cellular network,
wherein said emergency alert system decoder is operable to decode the encoded text data into decoded text data, and
wherein said transmitter is operable to transmit the warning transmission so as to include a text instruction based on the decoded text data.

4. The device of claim 1, further comprising:
a pairing component operable to pair with a networked device over a second wireless network; and
a controlling component operable to generate instructions, based on the emergency alert data, for the paired networked device so as to modify operation of the paired networked device,
wherein said transmitter is further operable to transmit an instruction signal, based on the instructions, to the paired networked device over the second wireless network so as to modify operation of the paired networked device.

5. The device of claim 4, wherein said transmitter is operable to transmit the instruction signal as one of the group consisting of a Wi-Fi signal, a Bluetooth signal and a Bluetooth Low Energy signal.

6. The device of claim 4,
wherein said receiver is further operable to receive a notification from the paired networked device based on a detected parameter,
wherein said warning generator is further operable to generate a second warning signal based on received notification, and
wherein said transmitter is further operable to transmit a notification transmission to the wireless communication device over the cellular network, the notification transmission being based on the second warning signal and the contact information.

7. A method of using a wireless communication device and a video display operable to display a video, said method comprising:
receiving, via a receiver, input data including image data and emergency alert system data;
decoding, via an image decoder, the image data into image display data;
decoding, via an emergency alert system, the emergency alert system data into emergency alert data;
outputting, via an output port, the image display data to the video display to display a video image;
storing, into a memory, contact information associated with the wireless communication device;
generating, via a warning generator, a warning signal based on the emergency alert data; and
transmitting, via a transmitter, a warning transmission to the wireless communication device over a cellular network, the warning transmission being based on the warning signal and the contact information.

8. The method of claim 7,
wherein said receiving comprises receiving the input data such that the emergency alert system data includes encoded audio data for transmission over the cellular network,
wherein said decoding the emergency alert system data into emergency alert data comprises decoding the encoded audio data into decoded audio data, and
wherein said transmitting the warning transmission comprises transmitting the warning transmission so as to include an audio instruction based on the decoded audio data.

9. The method of claim 7,
wherein said receiving comprises receiving the input data such that the emergency alert system data includes encoded text data for transmission over the cellular network,
wherein said decoding the emergency alert system data into emergency alert data comprises decoding the encoded text data into decoded text data, and
wherein said transmitting the warning transmission comprises transmitting the warning transmission so as to include a text instruction based on the decoded text data.

10. The method of claim 7, further comprising:
pairing, via a pairing component, with a networked device over a second wireless network;
generating, via a controlling component and based on the emergency alert data, instructions for the paired networked device so as to modify operation of the paired networked device; and
transmitting, via the transmitter, an instruction signal, based on the instructions, to the paired networked device over the second wireless network so as to modify operation of the paired networked device.

11. The method of claim 10, wherein said transmitting the instruction signal comprises transmitting the instruction signal as one of the group consisting of a Wi-Fi signal, a Bluetooth signal and a Bluetooth Low Energy signal.

12. The method of claim 10, further comprising:
receiving, via the receiver, a notification from the paired networked device based on a detected parameter;
generating, via the warning generator, a second warning signal based on received notification; and
transmitting, via the transmitter, a notification transmission to the wireless communication device over the cellular network, the notification transmission being based on the second warning signal and the contact information.

13. A non-transitory, tangible, computer-readable media having computer-readable instructions stored thereon, for use with a wireless communication device and a video display operable to display a video, the computer-readable instructions being capable of being read by a computer and being capable of instructing the computer to perform the method comprising:
receiving, via a receiver, input data including image data and emergency alert system data;
decoding, via an image decoder, the image data into image display data;
decoding, via an emergency alert system, the emergency alert system data into emergency alert data;
outputting, via an output port, the image display data to the video display to display a video image;
storing, into a memory, contact information associated with the wireless communication device;
generating, via a warning generator, a warning signal based on the emergency alert data; and
transmitting, via a transmitter, a warning transmission to the wireless communication device over a cellular network, the warning transmission being based on the warning signal and the contact information.

14. The non-transitory, tangible, computer-readable media of claim 13,
wherein the computer-readable instructions are capable of instructing the computer to perform the method such that said receiving comprises receiving the input data such that the emergency alert system data includes encoded audio data for transmission over the cellular network,
wherein the computer-readable instructions are capable of instructing the computer to perform the method such that said decoding the emergency alert system data into emergency alert data comprises decoding the encoded audio data into decoded audio data, and
wherein the computer-readable instructions are capable of instructing the computer to perform the method such that said transmitting the warning transmission comprises transmitting the warning transmission so as to include an audio instruction based on the decoded audio data.

15. The non-transitory, tangible, computer-readable media of claim 13,
wherein the computer-readable instructions are capable of instructing the computer to perform the method such that said receiving comprises receiving the input data such that the emergency alert system data includes encoded text data for transmission over the cellular network,
wherein the computer-readable instructions are capable of instructing the computer to perform the method such that said decoding the emergency alert system data into emergency alert data comprises decoding the encoded text data into decoded text data, and
wherein the computer-readable instructions are capable of instructing the computer to perform the method such that said transmitting the warning transmission comprises transmitting the warning transmission so as to include a text instruction based on the decoded text data.

16. The non-transitory, tangible, computer-readable media of claim 13, the computer-readable instructions being capable of being read by a computer and being capable of instructing the computer to perform the method further comprising:
pairing, via a pairing component, with a networked device over a second wireless network;
generating, via a controlling component and based on the emergency alert data, instructions for the paired networked device so as to modify operation of the paired networked device; and
transmitting, via the transmitter, an instruction signal, based on the instructions, to the paired networked device over the second wireless network so as to modify operation of the paired networked device.

17. The non-transitory, tangible, computer-readable media of claim 16, wherein the computer-readable instructions are capable of instructing the computer to perform the method such that said transmitting the instruction signal comprises transmitting the instruction signal as one of the group consisting of a Wi-Fi signal, a Bluetooth signal and a Bluetooth Low Energy signal.

18. The non-transitory, tangible, computer-readable media of claim 16, the computer-readable instructions being capable of being read by a computer and being capable of instructing the computer to perform the method further comprising:
receiving, via the receiver, a notification from the paired networked device based on a detected parameter;
generating, via the warning generator, a second warning signal based on received notification; and
transmitting, via the transmitter, a notification transmission to the wireless communication device over the cellular network, the notification transmission being based on the second warning signal and the contact information.
